(19) United States
(12) Patent Application Publication
(10) Pub. No.: US 2016/0254135 A1
(43) Pub. Date: Sep. 1, 2016

(54) DISCHARGE LAMP WITH OPTIMIZED SALT FILLING

(71) Applicant: KONINKLIJKE PHILIPS N.V., Eindhoven (NL)

(72) Inventors: Marcus Kubon, Aachen (DE); Gerald Scholak, Baesweiler (DE)

(21) Appl. No.: 15/150,196

(22) Filed: May 9, 2016

Related U.S. Application Data
(63) Continuation of application No. 11/574,414, filed on Feb. 28, 2007, now abandoned.

(30) Foreign Application Priority Data
Sep. 2, 2004 (EP) 04104229.2

(51) Int. Cl. H01J 61/12; H01J 61/30; F21S 8/10

(52) U.S. Cl. CPC H01J 61/125; F21S 48/1145; F21S 48/13; H01J 61/302

(57) ABSTRACT

A discharge lamp has a discharge vessel for generating an arc discharge between two electrodes. The discharge vessel contains an inert gas, and metal halides. The lamp further comprises an outer envelope surrounding the discharge vessel. The outer envelope is made of transparent material containing Potassium in a maximum concentration of 10 ppm by relation to the weight. The metal halides are contained in the discharge vessel in an amount of 3-6 μg/μl of the inner volume of the vessel, preferably 5±0.5 μg/μl. The lamp exhibits an improved long term lumen maintenance and may have a physical lifetime exceeding 4000 h net burning time.

### FIELD OF THE INVENTION

The present invention relates to a discharge lamp and a vehicle headlight with a discharge lamp.

### BACKGROUND

Known discharge lamps comprise a discharge vessel for generating an arc discharge between two electrodes. The discharge vessel contains an inert gas, such as Xenon, and metal halides, also referred to as salts. There are discharge lamps known with or without mercury contained in the discharge vessel. Light is generated by an electrical discharge between the electrodes. Metal halides, especially NaI and ScI₃ act as light emitting materials. Such discharge lamps are widely used, e.g. in automobile headlights.

U.S. Pat. No. 5,402,037 shows a discharge lamp with an arc tube sealingly charged with mercury, metal iodide and Xenon as inert gas. The discharge lamp is shown to have an arc tube which is not enclosed in a further envelope, and which has a volume of 20 to 50 μl. It is stated that a density of the mercury in the discharge vessel of 20-40 μg/μl and a density of metal iodide from 6-12 μg/μl, as well as a Xenon gas pressure of 3-6 atm is advantageous for arc tubes of good performance and uniformity with regard to voltage, luminous flux, color temperature and chromaticity.

In practical products today, the amount of metal halides contain in the discharge vessel is usually chosen to be above 8 μg/μl.

EP-A-1150337 shows a mercury-free metal halide lamp. The metal halide lamp includes a light-transmitting discharge vessel with a pair of electrodes. The discharge vessel has an ionisable gas filling containing a rare gas and a metal halide including at least Sodium (Na) or Scandium (Sc). The filling is substantially free of mercury. The rare gas is Xenon under a pressure of 3-15 atm. For the metal halide in the discharge vessel, an amount of 5-110 μg/μl is given. For a quick rise of luminous flux the amount of metal halide should be 30-55 μg/μl. In order to achieve a good color of visible light, an amount of metal halides of 5-35 μg/μl is proposed. Several examples show the salt filling consisting of different compositions including NaI, ScI₃, ZnI₂, DyI₃, TmI₃, NdI₃, CeI₃, HoI₃ and LiI. While exact values of the amount of salt per unit volume of the discharge space is not given, the examples show a relatively high amount of salt filling which is generally above 10 μg/μl.

A problem with discharge lamps is the loss of lumen output over lifetime. The lumen maintenance, measured in percent of lumen output compared to the initial value decreases at long term of e.g. 3000 h burning time up to values in the order of 40-50%.

### SUMMARY

It is therefore an object of the invention to propose a discharge lamp and vehicle headlight with improved long term lumen maintenance.

This object is solved according to the invention by a discharge lamp according to claim 1 and a vehicle headlight according to claim 9. Dependent claims refer to preferred embodiments.

According to the invention, the discharge lamp comprises an outer envelope surrounding the discharge vessel. The outer envelope is made of a transparent material, e.g. quartz glass material. This transparent material contains very little or no potassium (K) up to a maximum concentration of only 10 ppm by relation to the weight. A discharge lamp with a corresponding outer bulb is disclosed in US-A-2003 0048052, which is incorporated by reference here.

Further, the discharge lamp according to the invention comprises metal halides in a concentration of 3 to 6 μg/μl of volume.

The discharge vessel may contain mercury. However, it is also possible for the filling of the discharge vessel to be free of mercury.

Surprisingly it has been found that a lamp with the above characteristics has a lumen maintenance which is considerably improved over previously known lamps. In lamps according to the invention, a lumen maintenance of about 60% has been observed after 3500 h, whereas prior art lamps only exhibited considerably less. Also, the lamps according to the invention have shown to have an improved physical lifetime, which may even exceed 4000 h burning time.

Advantageously, the salts contained in the discharge vessel are halides from substances selected from the group comprising Na, Sc, In, Tl, Zn, Ce, Cs, Dy, Nd and Th. In preferred embodiments, NaI and ScI₃ with optional addition of InI and TlI are proposed.

Generally, it has shown to be highly advantageous for the total salt amount in the discharge vessel to be in the interval of 5±0.5 μg/μl. An even more preferred value would be 5±0.25 μg/μl. This value refers to the mean value considering a number of lamps of the same type. In production, tolerances may be around 5%-10%, which corresponds to 0.4-0.8 μg/μl.

A vehicle headlight according to the invention comprises a reflector and an above-described lamp arranged within the reflector. The reflector may be of parabolic or elliptical shape, or be alternatively a complex-shape reflector.

In the following, embodiments of the invention are described in detail with reference to the drawings. Where

### BRIEF DESCRIPTION OF THE DRAWINGS

FIG. 1 shows a side view of an embodiment of a discharge lamp;

FIG. 2 shows a diagram of lumen maintenance over burning time of lamps A1, A2 according to a first embodiment of the invention and a comparative example B;

FIG. 3 shows a diagram of lumen maintenance over burning time of a lamp C according to a second embodiment of the invention and a comparative example D.

### DETAILED DESCRIPTION

There are a large number of different designs of discharge lamps known. In the following, a discharge lamp will be generally described. However, it should be clear that the focus of the invention is on the filling of the discharge vessel and construction of the lamp with a special outer bulb, and that further design aspects mentioned are shown here as an example only.

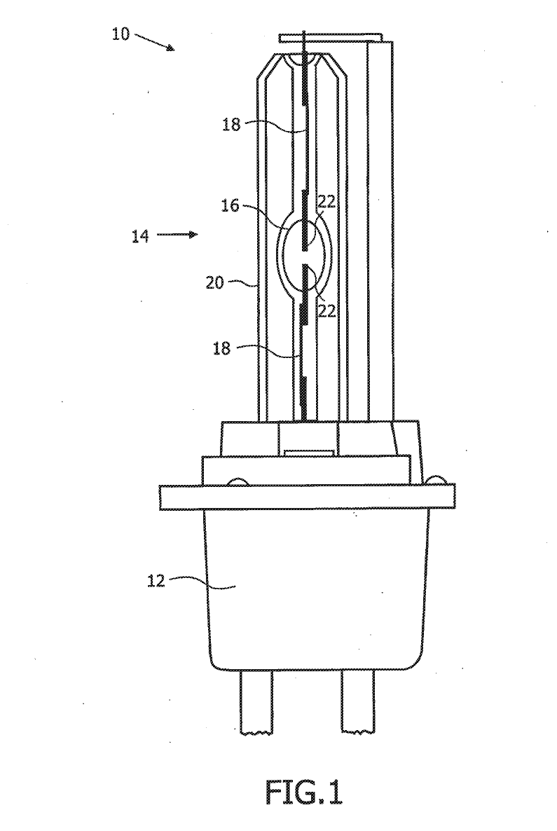

FIG. 1 shows in a side view a discharge lamp 10, comprising a socket 12 and a burner 14. The burner 14 comprises a discharge vessel 16 and lead wires 18 connected to electrodes 22 inside of the discharge vessel 16.

The discharge vessel 16 is made out of a translucent or transparent material, such as ceramics or quartz glass. The interior of discharge vessel 16 is sealed and contains a filling of Xenon as an inert gas and further components which will be discussed below. When a suitable voltage is applied at the electrodes 22, an arc discharge is created inside of discharge vessel 16.

The lamp 10 further comprises an outer bulb 20 of quartz glass, which is arranged around the discharge vessel 16.

The quartz glass material of outer bulbs 20 has a special composition. It contains very little Potassium (ca. 5 ppm) and a small amount of sodium (ca. 65 ppm). An example for an appropriate glass material would be Vycor, available from Corning, Inc. A discharge lamp with an outer bulb of the above described type is disclosed in US-A-2003 0048052. This document is incorporated by reference with the regard to the special composition of the material of outer bulb 20.

Surprisingly, lamps with an outer bulb of the above type exhibit considerably longer lifetime.

The filling within discharge vessel 16 contains Xenon as inert gas at a gas pressure of 4 to 12 bar. The filling further contains a quantity of mercury. Finally, the filling contains a certain amount of metal halides.

In a first embodiment of the invention, the details of the filling of discharge vessel 16 are as given below under A1, A2. In this embodiment, the amount of salt was 5 μg/μl. For comparison, a comparative example B with a salt filling corresponding to 10 μg/μl was tested.

| | | A1, A2 | | B | |
|---|---|---|---|---|---|
| | | (first embodiment) | | (comparative example) | |
| Inner volume of | | 30 | μl | 30 | μl |
| discharge vessel | | | | | |
| Inert gas Xenon | | 5.5 bar (cold pressure) | | 5.5 bar (cold pressure) | |
| gas pressure | | | | | |
| Salt filling | | 150 | μg | 300 | μg |
| Salt composition | NaI | 40 | wt % | 40 | wt % |
| | ScI₃ | 4 | wt % | 4 | wt % |
| | InI | 46 | wt % | 46 | wt % |
| | TlI | 10 | wt % | 10 | wt % |
| Hg | | 530 | μg | 530 | μg |

For each embodiment, batches of eight lamps were prepared and tested. For lumen maintenance tests, the lamps were switched according to a standard cycle with predetermined on and off times. For each lamp, lumen output was measured over net burning time, and mean values were calculated for each batch.

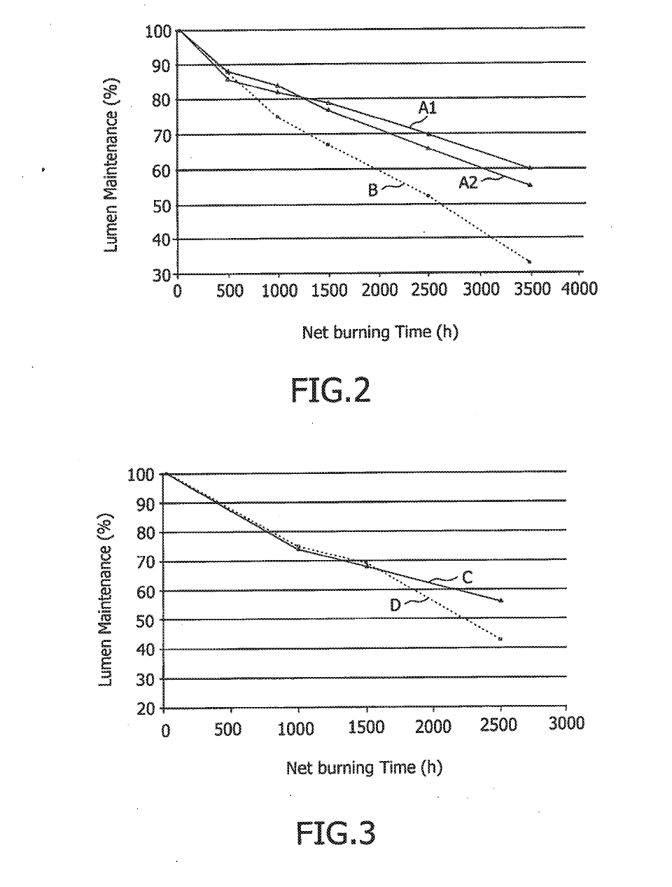

FIG. 2 shows in diagram form the lumen maintenance of two independent batches of lamps according to the first embodiment (lines A1, A2) by comparison to the comparative example (dashed line B). The lamps were tested up to a net burning time of 3500 h. At 500, 1000, 1500, 2500 and 3500 h the lumen output was measured and the lumen maintenance (where 100% corresponds to the lumen output at 15 h) was calculated.

FIG. 2 shows curves A1, A2 to be close together, thus demonstrating the reproducibility. FIG. 2 also shows that the lumen maintenance especially after long term tests (2500 h, 3000 h) of samples A1, A2 is significantly better than the comparative example. At 2500 h, samples A1, A2 are at 70 and 66% lumen maintenance, respectively, where as comparative example B is at only 52%. At 3500 h the difference is even more significant.

In a second embodiment C of the invention, the same amount of salt in the filling (5 μg/μl) was tested, but with a different salt composition. Again, a comparative example D (10 μg/μl) was tested.

| | | C | | D | |
|---|---|---|---|---|---|
| | | (second embodiment) | | (comparative example) | |
| Inner volume of | | 30 | μl | 30 | μl |
| discharge vessel | | | | | |
| Inert gas Xenon | | 5.5 bar (cold pressure) | | 5.5 bar (cold pressure) | |
| gas pressure | | | | | |
| Salt filling | | 150 | μg | 300 | μg |
| Salt composition | NaI | 70 | wt % | 70 | wt % |
| | ScI₃ | 30 | wt % | 30 | wt % |
| Hg | | 530 | μg | 530 | μg |

FIG. 3 shows for the above examples lumen maintenance over burning time up to 2500 h. While curve C shows up to a medium term duration of 1500 h about the same lumen maintenance as the comparative example D, it has considerably better long-term lumen maintenance. At 2500 h, second embodiment C shows about 56% lumen maintenance, while comparative example D only has 44% lumen maintenance.

As experiments have shown, the proposed reduction of metal halides, at least with the salt compositions used, does not seriously degrade lumen output. The lumen output for the above samples was

| | |
|---|---|
| A1/A2 | 2270 lm |
| B | 2290 lm |
| C | 2960 lm |
| D | 3050 lm. |

Additionally, further embodiments of the same lamp type (i.e. with identical geometry of the discharge vessel and identical filling with Xenon an Hg as above) are proposed with different salt compositions. However, in each case the amount of salts remains at 5 μg/μl, with production tolerance of about 5%.

According to a third embodiment, the composition of salts is as follows:

| | | |
|---|---|---|
| Salt composition | NaI | 60 wt % |
| | ScI₃ | 38 wt % |
| | InI | 2 wt % |

According to a fourth and fifth embodiment, the salt composition is as follows:

| 4^{th} embodiment | | 5^{th} embodiment | |
|---|---|---|---|
| Salt composition | NaI | 16 wt % | 16 wt % |
| | CsI | 9 wt % | 18 wt % |
| | CeI₃ | 25 wt % | 4 wt % |
| | DyI₃ | 25 wt % | 34 wt % |
| | NdI₃ | 25 wt % | 28 wt % |

While lamps according to the above first through fifth embodiment contain mercury, a lamp according to a sixth embodiment is Hg-free. The lamp contains ThI₄ and ZnI₂:

| | | |
|---|---|---|
| Salt composition | NaI | 53 wt % |
| | ScI₃ | 34 wt % |
| | InI | 1 wt % |
| | ThI₄ | 2 wt % |
| | ZnI₂ | 10 wt % |

Again, the lamp according to the sixth embodiment has a discharge vessel of 30 μm inner volume, which is filled with 150 μg of metal halides and Xenon at 5.5 bar.

In the above embodiments of the invention, the lamps showed considerably improved lumen maintenance.

It has thus been shown that the reduced amount of salt within the discharge vessel according to the invention leads to a lamp with improved long-term lumen maintenance.

1. Discharge lamp with
a discharge vessel (16) for generating an arc discharge between two electrodes (22), the discharge vessel (16) containing an inert gas, and metal halides,
that lamp (10) further comprising an outer envelope (20) surrounding that discharge vessel (16), said outer envelope (20) being made of a transparent material containing Potassium in a maximum concentration of 10 ppm by relation to the weight,
where said metal halides are contained in said discharge vessel in an amount of 3-6 μg/μl of the inner volume of the discharge vessel (16).

2. Lamp according to claim 1, where
said discharge vessel (16) further contains mercury.

3. Lamp according to claim 1, where
said discharge vessel (16) does not contain mercury.

4. Lamp according to claim 1, where
said metal halides are contained in said discharge vessel in an amount of 5±0.5 μg per μl of the inner volume of the discharge vessel (16).

5. Lamp according to claim 1, where
said transparent material of said outer envelope (20) contains Sodium in a minimum concentration of 10 ppm by relation to the weight.

6. Lamp according to claim 1, where
said metal halides comprise halides from substances selected from the group comprising Na, Sc, In, Tl, Zn, Ce, Cs, Dy, Nd and Th.

7. Lamp according to claim 6, where
said discharge vessel (16) contains as metal halides NaI and ScI₃.

8. Lamp according to claim 6, where
said discharge vessel (16) contains as metal halides NaI, ScI₃, InI and TlI.

9. Vehicle headlight comprising
a reflector,
and a lamp (10) according to one of the above claims arranged within said reflector.

10. Lamp according to claim 1, wherein the discharge vessel has a thickness of 1 to 1.8 mm.

11. Lamp according to claim 1, wherein the discharge vessel has a thickness of 1 to 2 mm.
